(19) United States
(12) Patent Application Publication
(10) Pub. No.: US 2023/0240296 A1
(43) Pub. Date: Aug. 3, 2023

(54) SEED TREATMENT FOR SAFENING WHEAT TO CHLOROACETAMIDE HERBICIDES

(71) Applicant: THE BOARD OF TRUSTEES OF THE UNIVERSITY OF ARKANSAS, Little Rock, AR (US)

(72) Inventor: Jason K. Norsworthy, West Fork, AR (US)

(21) Appl. No.: 18/103,947

(22) Filed: Jan. 31, 2023

Related U.S. Application Data
(60) Provisional application No. 63/305,118, filed on Jan. 31, 2022.

(51) Int. Cl. A01N 43/54; A01N 37/22; A01P 13/00

(52) U.S. Cl. CPC A01N 43/54; A01N 37/22; A01P 13/00

(57) ABSTRACT

The present invention provides methods of growing wheat. The methods comprise applying an effective amount of the safener fenclorim to wheat seed prior to planting and applying an effective amount of a Group 15 herbicide to the planting area.

### CROSS-REFERENCE TO RELATED APPLICATIONS

This application claims priority to U.S. Provisional Application No. 63/305,118 filed on Jan. 31, 2022, the contents of which are incorporated by reference in their entirety.

### BACKGROUND OF THE INVENTION

Wheat is a grass that is cultivated for its seed, a cereal grain that is a staple food worldwide. Ryegrass is the biggest weed competitor of wheat, and ryegrass populations that are resistant to all currently labeled effective postemergence herbicides are becoming more common. Improved methods for controlling ryegrass in wheat are, therefore, needed in the art.

### BRIEF SUMMARY OF THE INVENTION

The present invention provides methods for growing wheat. The methods comprise applying an effective amount of the safener, fenclorim, to wheat seed prior to planting and applying an effective amount of a Group 15 herbicide to the planting area. The herbicide may be a chloroacetamide herbicide, such as S-metolachlor. The herbicide may control ryegrass, annual bluegrass, and/or small-seeded broadleaf weeds, including herbicide-resistant ryegrass. The disclosed methods may provide a commercially acceptable rate of weed control and a commercially acceptable rate of crop injury.

### BRIEF DESCRIPTION OF THE DRAWINGS

FIG. 1 is a bar graph showing percent injury to wheat at two weeks after crop emergence. The wheat was seed treated with the safener fenclorim (0, 0.5, or 2.0 g/kg seed) and the planting area was treated preemergence with the herbicide S-metolachlor (0, 370, 750, or 1120 g ai/ha). Stars highlight data in which the fenclorim treatment reduced S-metolachlor-induced crop injury.

FIG. 2 is a bar graph showing percent injury to wheat at three weeks after crop emergence. The wheat was seed treated with the safener fenclorim (0, 0.5, or 2.0 g/kg seed) and the planting area was treated preemergence with the herbicide S-metolachlor (0, 370, 750, or 1120 g ai/ha). Stars highlight data in which the fenclorim treatment reduced S-metolachlor-induced crop injury.

FIG. 3 shows plot photos of wheat plants taken two weeks after crop emergence. The photos show safening provided by a fenclorim seed treatment (0.5 or 2.0 g/kg seed) against a preemergent application of S-metolachlor (750 g ai/ha).

### DETAILED DESCRIPTION OF THE INVENTION

The present invention provides methods of growing wheat. The methods comprise applying an effective amount of the safener fenclorim to wheat seed prior to planting and applying an effective amount of a Group 15 herbicide to the planting area. The methods may be used to grow any cultivated wheat variety. Exemplary cultivated wheat varieties include hard red winter, hard red spring, hard white, soft white, soft red winter, and durum wheat.

Herbicides

As used herein, the term “herbicide” refers to a substance used to control weeds. An herbicide may kill weeds or inhibit the growth or reproduction of weeds. Unless otherwise indicated, the names of herbicides recited herein are meant to refer to all commercially available forms of the herbicide, including salts, esters, free acids, free bases, and stereoisomers thereof.

“Group 15 herbicides” control weeds by inhibiting very long chain fatty acid synthesis. These herbicides are typically applied to soil and are primarily absorbed through seedling shoots and roots where they inhibit cell development and cell division. Thus, in the methods of the present invention, the herbicide is applied to the planting area (i.e., the soil surrounding positions at which seed has been planted or is to be planted). There are only five known weed species worldwide that are resistant to Group 15 herbicides, which suggests that there is a lower risk for developing resistance to this class of herbicides relative to others. Group 15 herbicides include herbicides in the chloroacetanilide chemical family (e.g., acetochlor, alachlor, S-metolachlor, dimethenamid, pethoxamid, pretilachlor, butachlor) and herbicides in the isoxazoline chemical family (e.g., pyroxasulfone). Suitable herbicides for use in the present methods include, without limitation, acetochlor, S-metolachlor, and dimethenamid.

Group 15 herbicides can be used to control a wide variety of weeds, i.e., plants that are considered a nuisance or a competitor of a commercially important crop. Examples of weeds that may be controlled using the methods of the present invention include, but are not limited to, winter annual broadleaf weeds, such as wild radish, chickweed, and henbit; small-seeded broadleaf weeds; perennials, such as wild garlic and curly dock; ryegrass, such as annual ryegrass and Italian ryegrass; and annual bluegrass. Although each of these weeds can be problematic, it is ryegrass that poses the greatest threat to wheat production. Thus, in preferred embodiments, the methods control ryegrass.

In some embodiments, the methods control “herbicide-resistant ryegrass,” i.e., ryegrass that is resistant to one or more herbicide. For example, in some embodiments, the methods control a ryegrass that is resistant to a postemergence herbicide. In some embodiments, the methods control a ryegrass that is resistant to a Group 1 herbicide (i.e., an ACCase inhibitor) such as diclofop or clethodim, a Group 2 herbicide (i.e., an ALS inhibitor) such as imazamox, a Group 9 herbicide (i.e., an aromatic amino acid inhibitor) such as glyphosate, a Group 10 herbicide (i.e., a glutamine synthesis inhibitor) such as glufosinate, or any combinations thereof.

In some embodiments, the herbicide S-metolachlor is utilized. S-metolachlor is a Group 15 herbicide that belongs to the chloroacetamide family. Currently, in the United States, it is labeled for use in corn, soybeans, sugar beets, sunflowers, and tomatoes. S-metolachlor controls weeds by inhibiting the growth of seedling shoots. It is effective when applied before germination; hence, it is typically applied before or immediately after a crop is planted. S-metolachlor provides preemergence control of many annual grasses (e.g., ryegrass) and a number of small-seeded broadleaf weeds.

In the methods of the present invention, the herbicide may be applied either before or after the wheat seed is planted. In some embodiments, the herbicide is applied before the seed is planted. For example, in some embodiments, the herbicide is applied to a field 1-250 days prior to planting. In some embodiments, the herbicide is applied via preplant incorporation, i.e., by mixing it into the surface soil before the seed is planted.

In other embodiments, the herbicide is applied after the seed is planted. In these embodiments, the herbicide application may be preemergence (i.e., the herbicide is applied after the crop seed is planted but before crop seedlings have emerged from the ground), delayed preemergence (i.e., the herbicide is applied at least four days after planting and as many as 14 days after planting but before crop seedlings have emerged from the ground), or postemergence (i.e., the herbicide is applied after crop seedlings have emerged from the ground but before the crop has matured). Compared to preemergent plants, emergent plants are typically relatively unaffected by seedling growth inhibitor herbicides. For that reason, herbicides had traditionally been applied after crop emergence but before weed emergence. Postemergence applications include early postemergence (EPOST) applications (i.e., applications made after crop emergence through early tillering stages), as well as applications at spiking (i.e., at emergence), at the one-to-two-leaf stage, and at the three-to-four-leaf stage.

Any herbicide formulation that is suitable for agricultural use may be used in the methods of the present invention. Suitable herbicide formulations include, without limitation, emulsifiable concentrates, soluble concentrates, and microencapsulated formulations.

“Emulsifiable concentrates” are oily liquid formulations that are prepared by dissolving an oil-soluble active ingredient in one or more organic solvents (e.g., benzene, toluene, xylene). Emulsifiable concentrates may additionally include surfactants or other additives. Prior to utilization, an emulsifiable concentrate is diluted in water to form an oil-in-water emulsion in which the active ingredient is in the organic phase.

“Soluble concentrates” are liquid formulations that are prepared by dissolving a water-soluble active ingredient in water. Soluble concentrates may additionally include surfactants or other additives.

“Microencapsulated formulations” are formulations in which an active ingredient is contained within a porous shell (e.g., a polymer shell), which serves to protect the active ingredient from degradation. For a detailed description of microencapsulated formulations, see U.S. Pat. No. 9,877,478, which is hereby incorporated by reference in its entirety. When exposed to soil moisture, the polymer shell dissolves, and the active ingredient is slowly released. Delayed release of the active ingredient gives the crop plant time to imbibe soil water and grow uninhibited before it is affected by the herbicide. In addition, gradual release allows the herbicide to provide longer residual control of weeds relative to non-microencapsulated formulations. In microencapsulated formulations, the release rate of the core material can be controlled through selection of several parameters, including: the shell composition, the core material composition, the weight ratio of the core material to shell material, the microcapsule particle size, and processing conditions such as mixing shear and time. In some formulations, a diluent, such as a solvent, may be added to change the solubility characteristics of the core material to alter the release rate. Any diluent may be used as long as it is compatible with the core material and the shell material. Microencapsulated formulations may comprise multiple populations of particles that each comprise a different core material composition. For example, a microencapsulated formulation may comprise particles with two different core material compositions in which the same active ingredient is mixed with two different solvents to provide a bimodal release rate. Additional ingredients may be added to the core material to improve its properties including, without limitation, thickeners, stabilizers, anti-packing agents, drift control agents, biocides, preservatives, antifreeze agents, and antifoam agents.

An “effective amount of herbicide” is an amount that provides a desired effect (e.g., commercially acceptable weed control) following either a single application or multiple applications. An effective amount of herbicide can be determined by one skilled in the art using known techniques. The effective amount of a particular herbicide is dependent upon several factors, including the formulation of the herbicide, the crop to be treated, and environmental conditions (e.g., the growing location, time of planting, soil type, moisture, abiotic stresses).

Generally, application rates of Group 15 herbicides are on the order of about 0.1, 0.2, 0.5, 1, 2, 3, 4 or 5 kilograms of herbicide per hectare. Thus, in some embodiments, the herbicide is applied at a rate of 0.1 to 5 kilograms per hectare, 0.2 to 4 kilograms per hectare, 0.25 to 2 kilograms per hectare, or 0.5 to 1 kilogram per hectare. In some embodiments, the herbicide is applied at a rate of at least 250 grams active ingredient per hectare (g ai/ha). In other embodiments, the herbicide is applied at a rate of at least 1,120 g ai/ha.

The methods of the present invention may further comprise applying an additional herbicide. Applying several herbicides with distinct mechanisms of action may be useful for treating fields with herbicide-resistant weeds. Examples of additional herbicides that can be used in the methods include, without limitation, ACCase inhibitors (e.g., aryloxyphenoxypropionics), enolpyruvyl shikimate-3-phosphate synthaste (EPSPS) inhibitors (e.g., glyphosate), glutamine synthetase inhibitors (e.g., glufosinate), synthetic auxins (e.g., aromatic acid, phenoxy, and pyridine herbicides), photosystem II (PS II) inhibitors (e.g., ureas and triazines), ALS or AHAS inhibitors (e.g., sulfonylureas, triazolopyrimidines, and imidazolinones), photosystem I (PS I) inhibitors (e.g., paraquat), protoporphyrinogen oxidase (PPO) inhibitors (e.g., diphenyl ethers, phenyl pyrazoles, aryl triazones, and oxadiazoles), mitosis inhibitors (e.g., anilide, amide, certain organophosphorus, and carbanilate herbicides), cellulose inhibitors (e.g., nitrile and oxazole herbicides), oxidative phosphorylation uncouplers, dihydropteroate synthase inhibitors, fatty acid and lipid biosynthesis inhibitors (e.g., thiocarbamate and certain organophosphorus herbicides), auxin transport inhibitors (e.g., amide and urea herbicides) and carotenoid biosynthesis inhibitors (e.g., isoxazolidinone, benzoylcyclohexanedione, and benzoylpyrazole herbicides), as well as salts, esters, and mixtures thereof.

Safener

In the methods of the present invention, fenclorim (4,6-dichloro-2-phenyl-pyrimidine) is used as a safener. As used herein, the word “safener” refers to a chemical that reduces the harmful effects of an herbicide on a cultivated plant. Ideally, a safener protects the cultivated plant without noticeably influencing the herbicide's effect on the weed(s) that it is meant to control. Fenclorim is an herbicide safener that belongs to the pyrimidine class and is used to protect crops from seedling damage.

As used herein, the word “safener” refers to a chemical that reduces the harmful effects of an herbicide on a cultivated plant. Safeners were formerly referred to as “antidotes,” and these terms may be used interchangeably. Ideally, a safener protects the cultivated plant without noticeably influencing the herbicide's effect on the weed(s) that it is meant to control.

At the molecular level, herbicides and their respective safeners are usually quite similar. As a result, safeners can act either as bioregulators of herbicides that influence the amount of an herbicide that reaches its target site in an active form or as antagonists of herbicides that compete with the herbicide for access to its site of action. While some safeners reduce the amount of herbicide reaching its site of action by reducing the rate of its uptake and/or translocation, most currently developed safeners function by enhancing the rate of metabolic detoxification of herbicide. For example, safeners that belong to several chemical classes (i.e., phenylpyrimidines, dichloroacetamides, oxime ethers, and thiazoles) are thought to protect plants against injury from chloroacetanilide herbicides (one class of Group 15 herbicides) by enhancing the conjugation of these herbicides to the reduced form of the thiol glutathione. After an herbicide is conjugated with glutathione in the cytoplasm, it is sequestered in a vacuole for degradation, resulting in its detoxification. Safeners can enhance herbicide conjugation to glutathione either by elevating the levels of reduced glutathione or by inducing the activity of the enzyme glutathione S-transferase, which catalyzes the conjugation of various substrates to glutathione.

Fenclorim may be applied to crops as a seed treatment or a seedling treatment, can be incorporated in the soil (e.g., in the furrow) before or after sowing seed, or can be applied together with the herbicide (e.g., as a tank mixture) before or after emergence of the plants. Thus, treatment of the plant or seed with this safener can be carried out independently of the of application of the herbicide, or alternatively, these treatments can be carried out simultaneously. In preferred embodiments, the fenclorim is applied as a “seed treatment” or “seed dressing”. Such treatments involve dusting or coating the seed with the safener.

In the methods of the present invention, the fenclorim may be applied either before or after the herbicide treatment. However, safeners are typically most effective when applied prior to or simultaneously with the herbicides whose injury they prevent. Thus, in preferred embodiments, the fenclorim is applied prior to or simultaneously with the herbicide. In specific embodiments, the fenclorim is applied as a seed treatment and the herbicide is applied preemergence.

An “effective amount of fenclorim” is an amount that provides a desired effect (e.g., a commercially acceptable rate of crop injury) following either a single application or multiple applications. An effective amount of fenclorim can be determined by one skilled in the art using known techniques. The effective amount of fenclorim is dependent upon several factors, including the formulation of fenclorim, the mode of application, the crop to be treated, and environmental conditions (e.g., the growing location, time of planting, soil type, moisture, abiotic stresses). When a safener is applied as a field treatment, either alone or as a tank mixture with an herbicide, the ratio of safener to herbicide is usually in the range of 1:100 to 10:1 but is more typically in the range of 1:5 to 8:1. However, when safeners are applied as a seed dressing, much smaller amounts (per hectare of crop area) are required than when they are applied later. For seed dressings, 0.1 to 10 g of safener is usually required per kg of seed. Thus, in some embodiments, the effective amount of fenclorim is between 0.1 to 5 g of fenclorim per kg of seed, 0.2 to 4 g of fenclorim per kg of seed, 0.3 to 3 g of fenclorim per kg of seed, or 0.5 to 2 g of fenclorim per kg of seed. In some embodiments, the effective amount of fenclorim is at least 0.5, 1.0, 1.5, or 2.0 g of fenclorim per kg of seed.

Any fenclorim formulation that is suitable for agricultural use may be used in the methods of the present invention. Examples of suitable formulations include directly sprayable solutions, dilutable solutions, emulsifiable concentrates, dilute emulsions, wettable powders, soluble powders, dusts, granulates, and encapsulations (e.g., in polymer substances). Fenclorim may be used in an unmodified form or may be included in a composition that comprises additional ingredients, such as solvents, carriers, surfactants, stabilizers, adjuvants, antifoams, viscosity regulators, binders, adhesives, as well as fertilizers or other active compounds.

Suitable safener solvents include, without limitation, aromatic hydrocarbons (preferably the fractions containing 8 to 12 carbon atoms) such as xylene mixtures or substituted naphthalenes, phthalates such as dibutyl phthalate or dioctyl phthalate, aliphatic hydrocarbons such as cyclohexane, or paraffins, alcohols and glycols and their ethers and esters, such as ethanol, ethylene glycol, ethylene glycol monomethyl or monoethyl ether, ketones such as cyclohexanone, strongly polar solvents such as N-methyl-2-pyrrolidone, dimethyl sulfoxide or dimethyl formamide, epoxidised vegetable oils such as epoxidised coconut oil or soybean oil, and water.

Suitable safener carriers include solid carriers, granulated adsorptive carriers, and nonsorbent carriers. Suitable solid carriers include mineral fillers such as calcite, talcum, kaolin, montmorillonite, and attapulgite. Highly dispersed silicic acid or highly dispersed absorbent polymers may be added to carriers to improve physical properties. Suitable granulated adsorptive carriers are porous materials such as pumice, broken brick, sepiolite, and bentonite. Suitable nonsorbent carriers are materials such as calcite or sand. In addition, a great number of pre-granulated materials of inorganic or organic nature can be used as a safener carrier, including dolomite and pulverized plant residues.

Suitable safener surfactants are described in the following publications: “McCutcheon's Detergents and Emulsifiers Annual”, MC Publishing Corp., Ringwood, N.J., 1979; and Sisely and Wood, “Encyclopedia of Surface Active Agents”, Chemical Publishing Co. Inc., New York, 1964; which are hereby incorporated by reference in their entireties.

Outcomes

The methods of the present invention provide weed control. As used herein, the term “weed control” describes when a weed is killed or removed or when a weed's growth, reproduction, or proliferation is inhibited. The weed control that is provided by a particular herbicide can be determined by visually assessing the weeds present in a plot treated with the herbicide and comparing them to the weeds observed in a control plot that was not treated with the herbicide. Weed control may be defined in terms of several measurements including, without limitation, weed mortality, weed growth, mass of weed plant material, and number of weed plants. Weed control may be provided as a percentage calculated by dividing a measurement obtained in the treated plot by the corresponding measurement obtained in the control plot.

As used herein, a “control plot” is a plot that is comparable to a treated plot but to which the treatment has not been applied. For example, a control plot should be of the same size and in the same general location as the treated plot, should have similar soil conditions (e.g., soil type, moisture, pH, nutrient quality), and should be subjected to similar abiotic stresses.

A “commercially acceptable rate of weed control” is a rate that is considered acceptable in the agriculture industry. This rate varies based on the weed species, degree of weed infestation, environmental conditions, and the associated crop plant. Commercially effective weed control may be defined as the destruction or inhibition of at least 50%, 55%, 60%, 65%, 70%, 75%, 80%, 85%, or 90% of weeds. Although, from a commercial viewpoint, it is generally preferable that 80% or more of the weeds are destroyed or inhibited, commercially acceptable weed control can occur at much lower levels, particularly with some very noxious, herbicide-resistant weeds. The herbicide application used in the methods of the present invention may achieve commercially acceptable weed control within 2 weeks, 3 weeks, 4 weeks, 5 weeks, 6 weeks, 7 weeks, 8 weeks, 9 weeks, 10 weeks, 11 weeks, or even 12 weeks of application.

In the Examples, the inventors demonstrate that treatment with the safener fenclorim protects wheat from injury caused by the herbicide S-metolachlor. Thus, in some embodiments, the methods of the present invention reduce herbicide-induced crop injury. The reduction in crop injury, due to a particular herbicide, provided by a particular safener can be determined by visually assessing crop injury in a plot of wheat treated with both the herbicide and the safener and comparing it to the crop injury observed in a control plot that was treated with the herbicide alone. Crop injury may be assessed by assigning the treated plot a rating on a scale of 0 to 100, wherein 0 indicates no crop injury and 100 indicates complete crop destruction. This score may be assigned, for example, by comparing the crop groundcover (i.e., green pixels) in the treated plot to that of the control plot using photographs.

A “commercially acceptable rate of crop injury” is a rate that is considered acceptable in the agriculture industry. This rate varies based on the crop variety. Typically, a commercially acceptable rate of crop injury is defined as injury to less than 20%, 18%, 16%, 15%, 13%, 12%, 11%, 10%, or 5% of crop plants. In preferred embodiments, a commercially acceptable rate of weed control and a commercially acceptable rate of crop injury are attained simultaneously.

Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Examples

Group 15 herbicides are promising candidates for controlling ryegrass in wheat. However, these herbicides are not currently registered for use in this crop. Thus, a field trial was conducted in Fayetteville, Ark. in fall of 2021 to test the ability of the safener fenclorim to protect wheat against the Group 15 herbicide S-metolachlor.

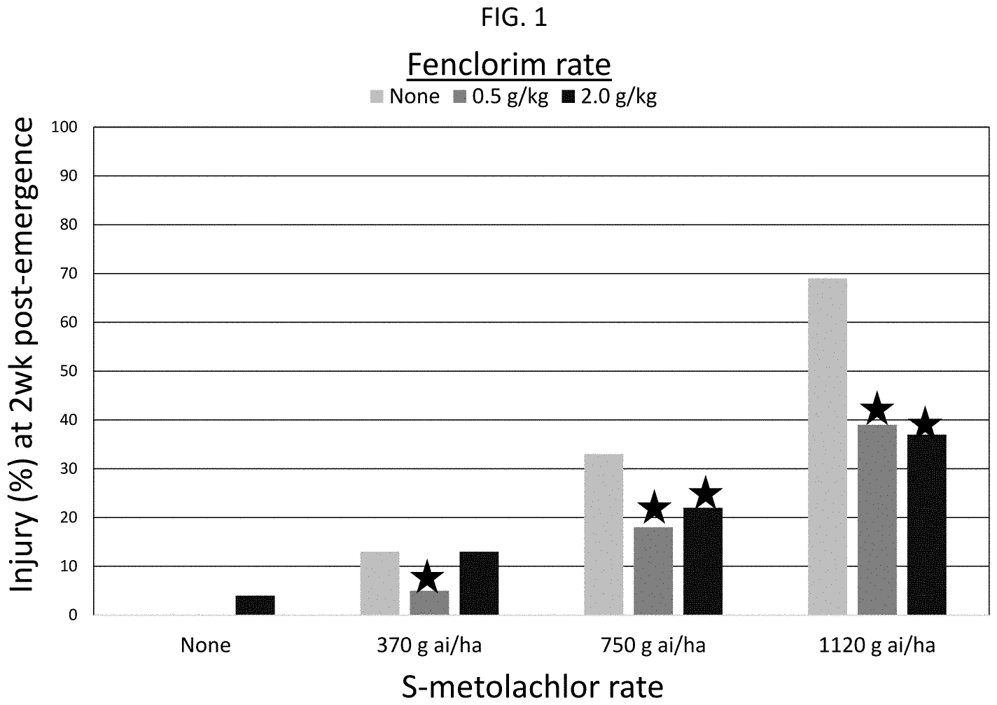

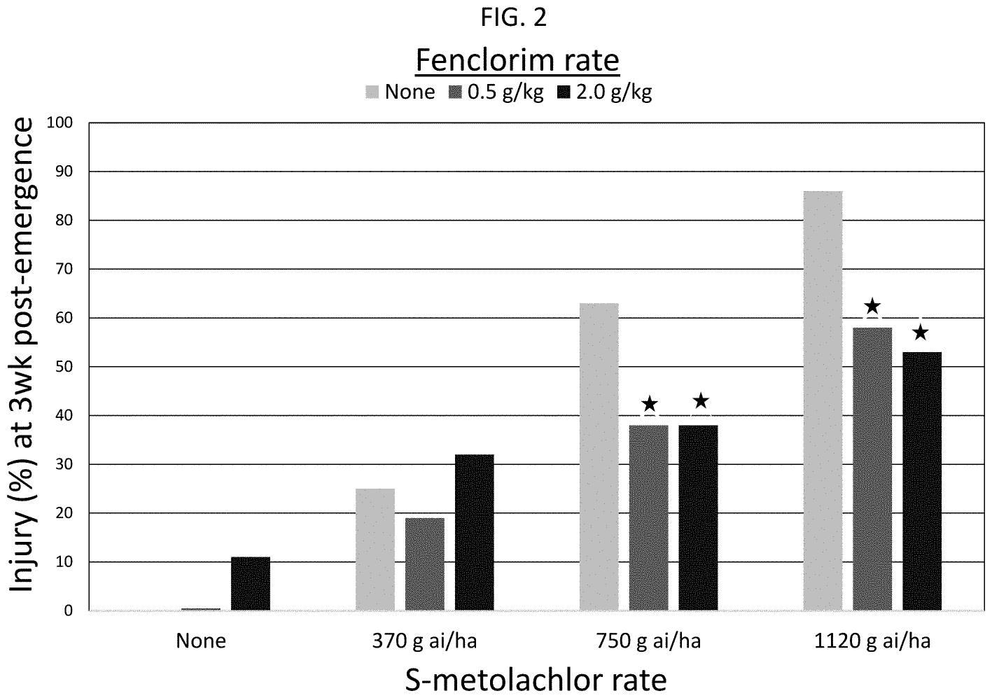

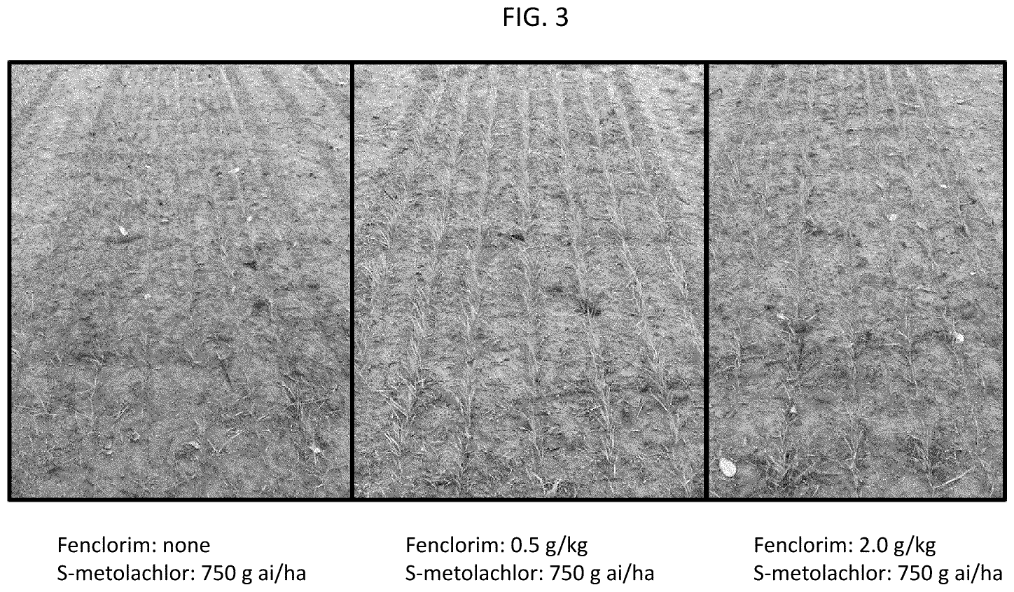

Seed from the conventional wheat cultivar ‘Smiths Gold’ was treated with various rates of the safener fenclorim (0, 0.5, and 2.0 g/kg seed). The seed was drill seeded in 9-row plots (4.5 m in length) and was immediately treated with a soluble concentrate formulation of S-metolachlor (0, 370, 750, and 1120 g ai/ha). Thus, the experimental setup was a two-factor design with factor A being the rate of safener application and factor B being the rate of herbicide application. The experimental site was dryland that received ample rainfall to activate the herbicide treatments approximately 7 days after application. All treatments were applied at 140 L/ha. Crop injury and control of ryegrass were evaluated at two and three weeks after crop emergence. The percentage of injury to wheat is graphed in FIG. 1 and FIG. 2. Representative plot photos of the treated wheat are shown in FIG. 3. These data demonstrate that significant safening was achieved with both rates of fenclorim (i.e., 0.5 and 2.0 g/kg seed) against the two highest rates of S-metolachlor (750 and 1120 g ai/ha).

1. A method of growing wheat comprising applying an effective amount of fenclorim to wheat seed prior to planting and applying an effective amount of a Group 15 herbicide to the planting area.

2. The method of claim 1, wherein the herbicide controls ryegrass, annual bluegrass, and/or small-seeded broadleaf weeds.

3. The method of claim 2, wherein the herbicide controls herbicide-resistant ryegrass.

4. The method of claim 1, wherein the herbicide is a chloroacetamide herbicide.

5. The method of claim 4, wherein the herbicide is S-metolachlor.

6. The method of claim 1, wherein the effective amount of the herbicide is between 0.1-5 kilograms active ingredient per hectare.

7. The method of claim 6, wherein the effective amount of the herbicide is at least 250 grams active ingredient per hectare.

8. The method of claim 1, wherein the effective amount of fenclorim is between 0.1-10 grams of safener per kilogram of seed.

9. The method of claim 8, wherein the effective amount of fenclorim is between 0.5-2 grams of safener per kilogram of seed.

10. The method of claim 1, wherein the herbicide is applied before the wheat seed is planted.

11. The method of claim 1, wherein the herbicide is applied after the wheat seed is planted.

12. The method of claim 11, wherein the herbicide application is preemergence, delayed preemergence, or at spiking.

13. The method of claim 1, wherein the herbicide is applied as an emulsifiable concentrate or a soluble concentrate.

14. The method of claim 1, wherein the herbicide is applied as a microencapsulated formulation.

15. The method of claim 1, wherein the fenclorim is applied to the wheat seed as a seed dressing.

16. The method of claim 1, wherein the wheat seed is hard red winter wheat seed, hard red spring wheat seed, hard white wheat seed, soft white wheat seed, soft red winter wheat seed, or durum wheat seed.

17. The method of claim 1, wherein the method reduces herbicide-induced crop injury.

18. The method of claim 1, wherein a commercially acceptable rate of weed control and a commercially acceptable rate of crop injury are simultaneously attained.
